(19) United States
(12) Patent Application Publication
(10) Pub. No.: US 2006/0085732 A1
(43) Pub. Date: Apr. 20, 2006

(54) Method and system for editing and using visual bookmarks

(76) Inventors: Tony Jiang, Taipei (TW); Andery Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/088,734

(22) Filed: Mar. 25, 2005

(30) Foreign Application Priority Data
Oct. 14, 2004 (TW) 093131095

(51) Int. Cl. G06F 17/24

(52) U.S. Cl. 715/501.1

(57) ABSTRACT

A method and system for recording or selecting visual bookmarks in the process of playing a multimedia data are disclosed, wherein users can play the multimedia data at one of the mark in point. The visual bookmarks are represented by playing the sounds or the pictures at the mark in point in the multimedia data. Thus, users can directly understand where the mark in point of each visual bookmark is in the multimedia data.

### BACKGROUND OF THE INVENTION

1. Field of the Invention

The present invention generally relates to the bookmarks for playing the video/audio, and more particularly to the bookmarks for playing the video/audio in visual effects.

2. Description of the Prior Art

A media for playing multimedia information (i.e. audio information, video information or audio/video information) often supports the features for forwarding, backing and so forth. People can speed up to find out the demanded playing content with said features. This is because that the playing process is sequential, people have to find out the previous playing content by the manners to hear or to watch manually if there is no record of the playing content reserved. It is inconvenient and costs much time.

Therefore, some multimedia players support the features of bookmarks, providing users to record one or several playing contents arbitrarily in the process of playing multimedia. Thus users can arbitrarily choose one of the bookmarks with a playing content for resuming the multimedia playing. Referring to FIG. 1A, step 110 plays the multimedia data according to a demanded playing content. Then step 120 repeatedly detects a first instruction. When a first instruction is detected, step 130 and step 140 pauses the multimedia playing and display a bookmark menu separately. After that step 150 waits for receiving a second instruction and executes the received second instruction to operate the bookmarks menu. Afterwards step 161 edits the bookmarks menu or chooses one of the bookmarks to change the demanded playing content of playing multimedia according to the second instruction. Finally, step 171 and step 180 close the bookmarks menu and proceed playing the multimedia separately. The layouts of such bookmarks are shown by text or nothing more than the corresponding time, whereby the bookmarks are hard to associate with their layouts in thinking. An adapted bookmark can only be found by testing the bookmarks one by one.

Moreover, for some multimedia data, pre-determined intervals of a multimedia data are built in the multimedia data itself or evaluated by some multimedia players. The first frame of each interval within the multimedia data can be displayed, whereby users can decide which interval is demanded. Referring to FIG. 1B, step 110 plays a multimedia data according to a demanded playing content. The step 120 repeats to detect a first instruction. After a first instruction is detected, step 130 and step 140 will pause the multimedia playing and display a digest window. Then step 150 waits for a second instruction and performs the operation of the digest window after a second instruction is received. Afterwards, step 162 select a digest window to change the demanded playing content according to the received second instruction. Finally, step 172 and step 180 close digest window and resume playing multimedia data. However, such a feature is predefined and users just can use them on hand. Besides, the displayed playing content of each digest window could not be satisfied by users. Speeding up to find out the exact demanded frames from the displayed playing contents of these digest windows is one advantage of the digest windows. Moreover, users can figure out which digest window could be mostly close to the demanded playing content with the frame representation. However, if users have no idea about contents of the multimedia data, the feature may not be needed.

Obviously, both of bookmarks menu and digest window have their own advantages and disadvantages. To draw on the strength of each to offset the weakness of the other will accomplish multimedia data playing.

### SUMMARY OF THE INVENTION

Therefore, in accordance with the previous summary, contents, features and advantages of the present disclosure will become apparent to one skilled in the art from the subsequent description and the appended claims taken in conjunction with the accompanying drawings.

The present invention provides the visual bookmarks, whereby the users can acquire the relative frames, or the demanded playing content, when the visual bookmarks are recorded or selected.

Accordingly, one embodiment of the present invention provides a method for using and editing visual bookmarks, comprising: detecting a first instruction and executing the first instruction on a multimedia data been played; and waiting for a second instruction and executing the second instruction on the visual bookmarks when the second instruction is received after the arrival of the first instruction. Multimedia data is played according to a demanded playing content. The first instruction comprises displaying a digest window that comprises a plurality of visual bookmarks, wherein each of the visual bookmarks is displayed by a visual window respectively. Besides, the second instruction is a set selected from the following group: editing the visual bookmarks; selecting one of the visual bookmarks to change the demanded playing content for the multimedia data; and closing the digest window.

Another embodiment of the present invention provides a system for using and editing visual bookmarks, comprising: restoring apparatus for recording a plurality of visual bookmarks; playing apparatus for playing a multimedia data on a display apparatus according to a demanded playing content; instruction apparatus for receiving a first instruction and a second instruction, wherein the second instruction is received after the first instruction; and interrupting apparatus for executing the first instruction when the first instruction is received and executing the second instruction on the visual bookmarks when the second instruction is received. The first instruction comprising the operation for requesting to display a digest window with the visual bookmarks on the display apparatus, wherein each of the visual bookmarks is displayed by one of the visual window respectively. Besides, the second instruction is a set selected from the following instruction group: editing the visual bookmarks; selecting one of the visual bookmarks to change the demanded playing content for the demanded multimedia data; and closing the digest window.

### BREIF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A and FIG. 1B are diagrams illustrates the prior art;

FIG. 2 and FIG. 3 are diagrams depicts flowing diagrams in one embodiment of the present invention; and

FIG. 4 is a diagram shows a functional diagram in another embodiment of the present invention.

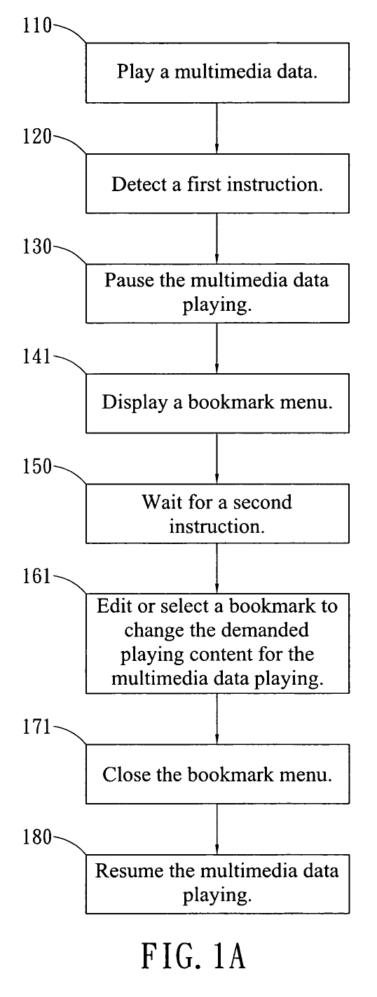

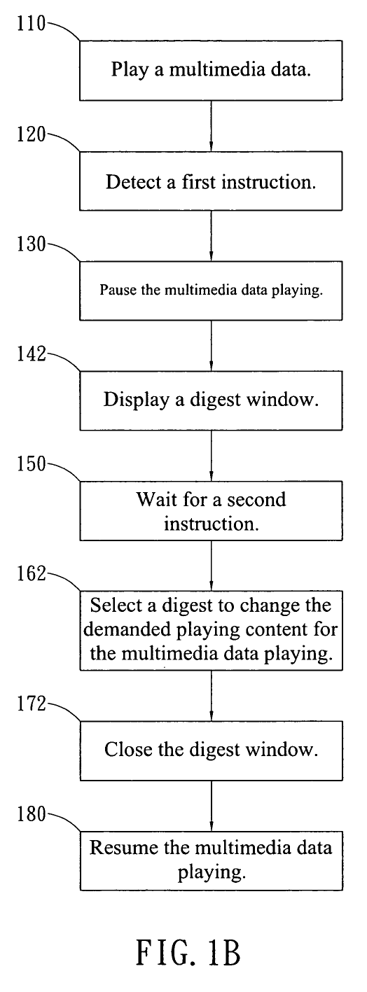

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents comprised within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

One embodiment of the invention is a method for using and editing visual bookmarks. Essentially, the embodiment receives an external instruction while the multimedia is playing, showing a digest view according to the external instruction, showing one or more visual bookmarks in the digest view, and changing the demanded playing content to be played according to which visual bookmark is selected or saving the current playing content as a visual bookmark.

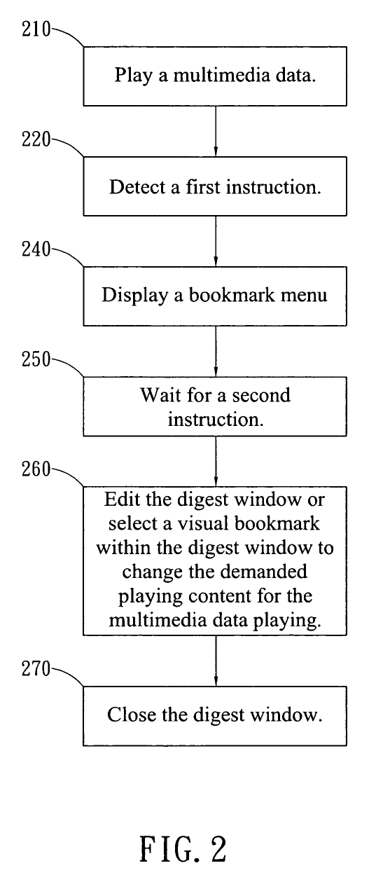

FIG. 2 is a diagram of the embodiment. Firstly step 210 play a multimedia data, which can be a set selected from the following group: sound, graph, video or the like. Besides, the multimedia data is displayed as a series of frames according to the playing content of each frame. Even if the multimedia data contains only a graph, the graph is displayed as a series of the same frames. Next, step 220 detects a first instruction, which is triggered by a signal issued from a remote controller, a keystroke, a voice controlled apparatus, a charge coupled apparatus or the like. Then the multimedia data is performed according to the first instruction, as shown in step 240, which illustrates that the multimedia data is performed as a digest window. The digest window contains one or a plurality of visual bookmarks. Each visual bookmark is shown as an visual window that shows the contents of a playing information, comprising: frames, playing content, chapter, time, the frame within the multimedia data at the playing content, the identification information of the multimedia data, the frames in a duration from the playing content within multimedia data. Moreover, step 250 waits for a second instruction to proceed the next operation, i.e. editing or selecting visual bookmarks (as shown in step 260) or close the digest window (as shown in step 270).

The above-mentioned visual bookmarks can be provided for statically or dynamically display. For examples, the displaying information of a visual bookmark in the visual window can be a repeatedly displayed frame (statically display) or all frames in a duration of multimedia data for playing (dynamically display) on a display area within the digest window. The visual window can be minified for suiting the display area or partially displayed. Besides, the visual bookmarks shown on the digest window can be statically displayed except the selected one and the selected visual bookmark can be dynamically displayed. For examples, the first frame or all of the series of frames of the multimedia data in the duration starting from the playing content are displayed according to whether the respective visual bookmark is selected or not respectively. The dynamically playing above mentioned comprises the playing of audio, video or audio/video, and number of times can be one, many or unlimited.

Moreover, operations for editing visual bookmarks in step 260 comprise insertion, modification, deletion, remove, configuration and so on. In the other hands, the second instruction can be a series of operations for visual bookmarks, i.e. inserting or modifying one of the visual bookmarks according to the playing information. More illustrations can comprise: deleting one or more visual bookmarks, ordering the arrangement of visual bookmarks, configuring the playing contents, i.e. the range for display, of the visual bookmarks and so forth. Furthermore, the recorded playing content in a visual bookmark can be the playing content at the arrival of the first instruction, or at the moment for editing each visual bookmark. In addition, the visual bookmarks shown on the digest window may contain only the information recorded for the displayed multimedia data in step 210.

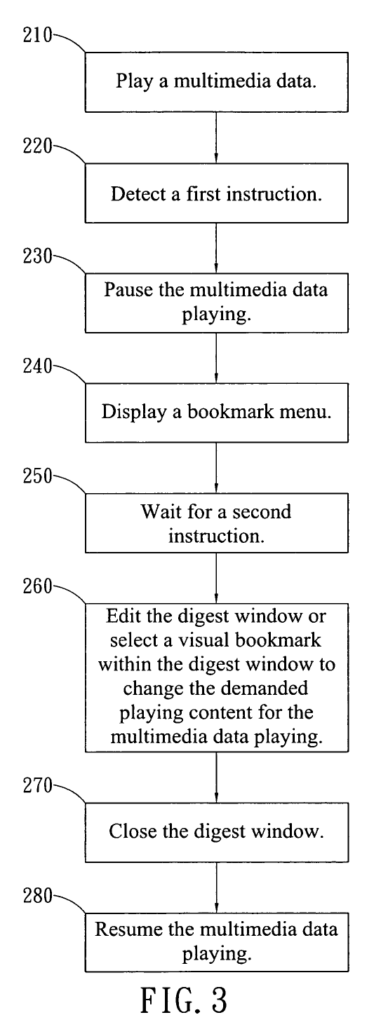

In step 260, multimedia data may be in the progress of playing or paused. Referring to FIG. 3, the present embodiment further comprises recording the playing information when the playing of the multimedia data is paused. The playing information of a visual bookmark mentioned in step 260 can be recorded by the playing information at the moment that the multimedia data playing is paused. Corresponding to step 230, the present embodiment can further comprises step 280, which resumes the multimedia data playing according to the playing content within the playing information. That is, step 280 runs after step 230. The multimedia data playing can be paused and resumed at the arrival of the first instruction and the second instruction separately, and the times for pausing and proceeding the playing of the multimedia data can be once or more.

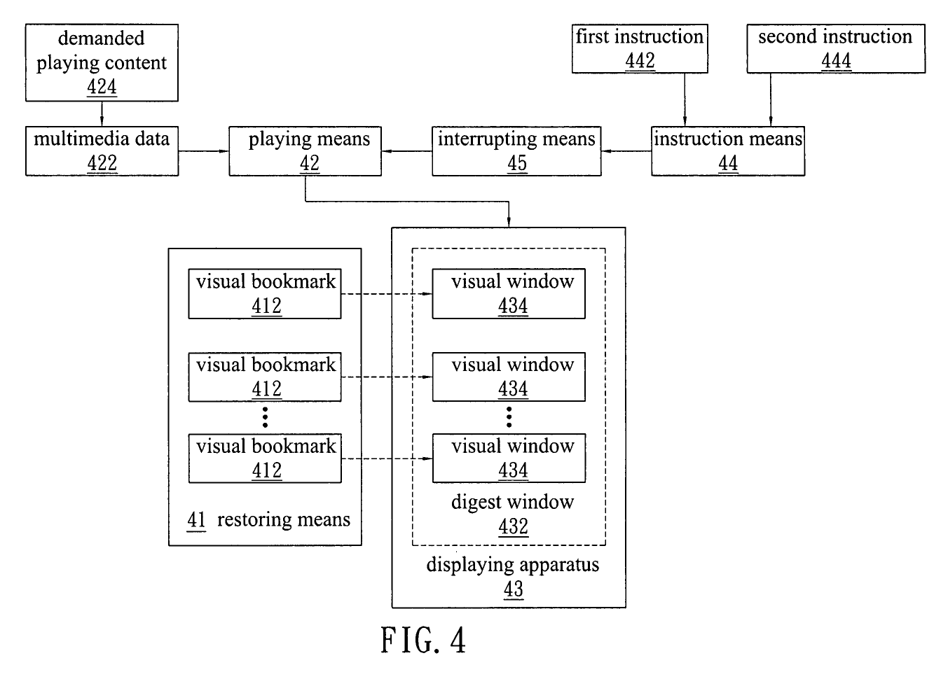

Accordingly, another embodiment of the present invention is a system for editing visual bookmarks. Referring FIG. 4, the system for editing visual bookmarks comprises: a restoring apparatus 41 for recording a plurality of visual bookmarks 412; a playing apparatus 42 for playing a multimedia data on a display apparatus 43 according to a playing content 424; a instruction apparatus 44 for detecting a first instruction 442 and waiting for a second instruction 444, wherein the second instruction 444 is received after the first instruction 442; an interrupting apparatus 45 for executing the first instruction 442 when the first instruction 442 is detected, wherein the first instruction 442 comprising the operations for requesting to display a digest window 432 on the display apparatus 43 that comprises a plurality of visual windows of visual bookmarks 412; and executing the second instruction 444 on the plurality of visual bookmarks 412. Herein, each of the above apparatus could be implemented by a hardware (such as a integrated circuit), a software (such as a micro code) or a firmware, the invention only limits their function(s) but not limit their details. For example, the restoring apparatus 41 could be any memory, the playing apparatus 42 oculd be any well-known display, the instruction apparatus 44 could be any circuit for receiving instructions, such as well-known circuit for receiving instruction from the user interface of a television, and the interrupting apparatus 45 could be a micro-controller for switching the operation of some circuits.

The foregoing first instruction further comprises recording the playing information of the multimedia data 422, wherein the playing information comprises: graph, playing content 424, chapter, recording time, the frame of the multimedia data at the playing content, identification information of the multimedia data 422, and all frames in a duration starting at the playing content of the multimedia data. The foregoing second instruction 444 is selected from the group of the following: editing said plurality of visual bookmarks 412 and requesting the display apparatus 43 to refresh the display of the digest window; selecting one of the visual bookmarks 412 to change the playing content 424 and requesting the display apparatus 43 to refresh the display of the digest window; and requesting the apparatus 42 to close the digest window 432. Thus the forgoing visual windows of the visual bookmarks may contains: the display of the playing content 424, the display of the identification information, the display of the frame of the multimedia data 422 at the progress rate, the display of all frames in a duration starting on the playing content 424 of the multimedia data 422. The display of all of the frames in a duration of the multimedia data 422 on a respective visual window can be only the first frame of all of the frames in the duration of the multimedia data 422 when the respective visual bookmark is not selected, and all of the frames in a duration of said multimedia data can be displayed once or repeatedly when the respective visual bookmark is selected. Moreover, the respective audio of the multimedia data can be played simultaneously, the present invention does not limited the contents and time for playing the multimedia data.

Accordingly, the operation for editing the visual bookmarks 412 can be made by maintaining the playing information for insertion, modification, deletion, move, configuration or so on. That is, the second instruction 444 is a series of instruction for operating the visual bookmarks 412. Besides, the operating for selecting the visual bookmarks 412 within the second instruction 444 can be used to change the playing content 424. The operation for editing or selecting the visual bookmark 412 can be operated in the meanwhile multimedia data 422 is played or paused. Pausing or resuming the playing can be triggered by the first instruction 442 and the second instruction 444 separately. Alternatively, Pausing or resuming the playing can be triggered by the second instruction 444 only. Accordingly, users can edit or operate the digest window 432 to pause or resume the playing. Other details of the embodiment have described in the last embodiment and no redundant description will be made here.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A method for using and editing visual bookmarks, comprising:
detecting a first instruction and executing said first instruction on a multimedia data been played, wherein multimedia data is played according to a demanded playing content, wherein said first instruction comprises displaying a digest window that comprises a plurality of visual bookmarks, wherein each of said visual bookmarks is displayed by a visual window respectively; and
waiting for a second instruction and executing said second instruction on said visual bookmarks when said second instruction is received after the arrival of said first instruction, wherein said second instruction is a set selected from the following group:
editing said visual bookmarks;
selecting one of said visual bookmarks to change said playing content for said multimedia data; and
closing said digest window.

2. The method for using and editing visual bookmarks of claim 1, wherein said first instruction further comprises recording the playing information of said multimedia data into one of said visual bookmarks, wherein said multimedia data comprises said playing content and said visual window comprises the display of said playing content.

3. The method for using and editing visual bookmarks of claim 2, wherein said displaying information further comprises an identification information, wherein said visual window comprises the display of said identification information.

4. The method for using and editing visual bookmarks of claim 2, wherein said playing information further comprises an frame at said demanded playing content, wherein said visual window comprises the display of said frame at said demanded playing content.

5. The method for using and editing visual bookmarks of claim 2, wherein said playing information further comprise all of the frames in a duration of said multimedia data, wherein said visual window comprises the display of all of the frames in a duration of said multimedia data.

6. The method for using and editing visual bookmarks of claim 5, wherein only the first frame of all of the frames in a duration of said multimedia data is displayed when the respective visual bookmark is not selected, and all of the frames in a duration of said multimedia data are displayed when the respective visual bookmark is selected.

7. The method for using and editing visual bookmarks of claim 2, wherein editing said visual bookmarks is to assign said displaying information to be the contents of one of said visual bookmarks.

8. The method for using and editing visual bookmarks of claim 2, wherein editing said visual bookmarks is to generate a new visual bookmark with said displaying information.

9. The method for using and editing visual bookmarks of claim 1, wherein said first instruction further comprises pausing the playing of said multimedia data and said second instruction further comprises resuming playing said multimedia data according to said demanded playing content.

10. The method for using and editing visual bookmarks of claim 1, wherein said group further comprises pausing the playing of said multimedia data and resuming playing the multimedia data.

11. A system for using and editing visual bookmarks, comprising:
restoring apparatus for recording a plurality of visual bookmarks;
playing apparatus for playing a multimedia data on a display apparatus according to a demanded playing content;
instruction apparatus for receiving a first instruction and a second instruction, wherein the second instruction is received after the first instruction; and
interrupting apparatus for executing said first instruction when said first instruction is received and executing said second instruction on said visual bookmarks when said second instruction is received, wherein said first instruction comprising the operation for requesting to display a digest window with said visual bookmarks on said display apparatus, wherein each of said visual bookmarks is displayed by one of said visual window respectively, wherein said second instruction is a set selected from the following instruction group:
editing said visual bookmarks;
selecting one of said visual bookmarks to change said demanded playing content for said multimedia data; and
closing said digest window.

12. The method for using and editing visual bookmarks of claim 11, wherein said first instruction further comprises recording the playing information of said multimedia data into one of said visual bookmarks, wherein said multimedia data comprises said playing content and said visual window comprises the display of said playing content.

13. The method for using and editing visual bookmarks of claim 12, wherein said displaying information further comprises an identification information, wherein said visual window comprises the display of said identification information.

14. The method for using and editing visual bookmarks of claim 12, wherein said playing information further comprises an frame at said demanded playing content, wherein said visual window comprises the display of said frame at said demanded playing content.

15. The method for using and editing visual bookmarks of claim 12, wherein said playing information further comprise all of the frames in a duration of said multimedia data, wherein said visual window comprises the display of all of the frames in a duration of said multimedia data.

16. The method for using and editing visual bookmarks of claim 15, wherein only the first frame of all of the frames in a duration of said multimedia data is displayed when the respective visual bookmark is not selected, and all of the frames in a duration of said multimedia data are displayed when the respective visual bookmark is selected.

17. The method for using and editing visual bookmarks of claim 12, wherein editing said visual bookmarks is to assign said displaying information to be the contents of one of said visual bookmarks.

18. The method for using and editing visual bookmarks of claim 12, wherein editing said visual bookmarks is to generate a new visual bookmark with said displaying information.

19. The method for using and editing visual bookmarks of claim 11, wherein said first instruction further comprises pausing the playing of said multimedia data and said second instruction further comprises resuming playing said multimedia data according to said demanded playing content.

20. The method for using and editing visual bookmarks of claim 11, wherein said group further comprises pausing the playing of said multimedia data and resuming playing the multimedia data.
